(19) United States
(12) Patent Application Publication
(10) Pub. No.: US 2002/0060290 A1
(43) Pub. Date: May 23, 2002

(54) Method for analysis of analytes by mass spectrometry

(75) Inventor: Thang T. Pham, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ciphergen Biosystems, Inc., Fremont, CA

(21) Appl. No.: 09/812,307

(22) Filed: Mar. 19, 2001

Related U.S. Application Data
(60) Provisional application No. 60/190,764, filed on Mar. 20, 2000.

(51) Int. Cl. H01J 49/04

(52) U.S. Cl. 250/282; 250/288

(57) ABSTRACT

This invention provides a method for analyzing analytes in a sample by mass spectrometry. The method involves pre-fractionating the sample by size exclusion and/or ion exchange chromatography, applying the sample to an adsorbent attached to the surface of a mass spectrometry probe, and allowing both specific and non-specific adsorption of analytes the adsorbent (e.g., by allowing the sample to dry without washing to remove unbound sample). Then an energy absorbing material is added to the dried sample, and the sample is analyzed by laser desorption/ionization mass spectrometry.

### CROSS-REFERENCES TO RELATED APPLICATIONS

This application claims the benefit of U.S. Provisional Patent application Serial No. 60/190,764, filed on Mar. 20, 2000, the teachings of which are herein incorporated by reference.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

Mass spectrometry has become an increasingly popular method for the analysis of proteins. Its popularity has been increased by the development of methods to inhibit the fragmentation of proteins during the process of volatilization (e.g., desorption) and ionization and of improving the resolution of proteins in a complex sample mixture. Such methods are described in, for example, U.S. Pat. No. 5,118,937 (Hillenkamp et al.), U.S. Pat. No. 5,617,060 (Hutchens and Yip) and WO 98/59360 (Hutchens and Yip).

There is a need for improved methods of analysis of proteins by mass spectrometry.

### SUMMARY OF THE INVENTION

In one aspect, this invention provides a method for resolving bimolecular analytes in a sample. The method involves: a) providing a probe for a gas phase ion spectrometer, the probe comprising a substrate having a surface and, an adsorbent bound to the surface; b) contacting a sample with the adsorbent to allow both specific and nonspecific adsorption to the adsorbent, e.g., by allowing the sample to dry without removing unbound analyte; and c) desorbing and ionizing analytes in the sample from the surface and detecting the desorbed, ionized analytes with a gas phase ion spectrometer. Thus, the sample is contacted with a surface that plays an active role in the desorption process and does not function merely as a stage. The adsorbed analyte can then be covered with an energy absorbing molecule to facilitate desorption. However, the sample is not mixed with the energy absorbing material before application to the probe, as in traditional MALDI. In certain embodiments, the gas phase ion spectrometer is a mass spectrometer and, more specifically, a laser desorption/ionization mass spectrometer. The adsorbent is, preferably, a hydrophilic adsorbent comprising silicon oxide. In other embodiments, an energy absorbing material is applied to the dried sample to facilitate desorption and ionization.

In other embodiments, the sample is fractionated prior to contacting with the adsorbent. For example, the sample can be size fractionated. Size fractionation can be performed with, for example, size exclusion chromatography. The sample also can be fractionated by affinity chromatography before application. For example, chromatography can be anion exchange, cation exchange or affinity chromatography. These methods decrease the complexity of the sample and improve resolution of the analytes.

In another aspect, the invention provides methods for detecting bioorganic molecules in a sample. The methods involve contacting a sample comprising bioorganic molecules with an adsorbent surface of a probe and concentrating the bioorganic molecules in the sample on the adsorbent surface. Then, the bioorganic molecule(s) on the adsorbent surface of the probe are detected by gas phase ion spectrometry. In certain embodiments, the gas phase ion spectrometry involves laser desorption/ionization mass spectrometry. The samples can be derived or obtained from a variety of sources. The sample can contain a biological fluid such as saliva, blood, urine, lymphatic fluid, prostatic fluid, seminal fluid, milk, a cell extract and cell culture medium.

The sample can be pre-fractionated by size exclusion chromatography and/or ion exchange chromatography before contact with the adsorbent surface. The adsorbent can be selected from a variety of materials and combination of materials. In some embodiments, the adsorbent can be a hydrophilic adsorbent or a hydrophobic adsorbent. The adsorbents can also contain silicon oxide.

In some embodiments, the concentrating step involves concentrating the sample to dryness. In other embodiments, the concentrated sample also involves applying an energy absorbing material to the probe after concentrating. Examples of energy absorbing molecules include, but are not limited to, a cinnamic acid derivative, sinapinic acid and dihydroxybenzoic acid.

In yet another aspect, the invention provides for methods for detecting bioorganic molecules in a sample. These methods involve contacting a sample containing bioorganic molecules with an adsorbent surface of a probe and allowing the sample to reach binding equilibrium with the adsorbent. Then sample liquid is removed from the adsorbent surface without washing the adsorbent surface. The bioorganic molecules on the adsorbent surface of the probe are then detected by gas phase ion spectrometry. The gas ion spectrometry can involve laser desorption/ionization mass spectrometry.

The samples can contain a biological fluid that is selected from fluids such as saliva, blood, urine, lymphatic fluid, prostatic fluid, seminal fluid, milk, a cell extract and cell culture medium. In some embodiments, the sample can be pre-fractionated by size exclusion chromatography and/or ion exchange chromatography before contact with the adsorbent surface. The adsorbents used in this aspect of the invention can include, without limitation, a hydrophilic adsorbent and a hydrophobic adsorbent. In some embodiments, the adsorbent contains silicon oxide.

After the liquid sample has been removed, in certain embodiments, an energy absorbing material is applied to the probe. Examples of energy absorbing materials include, but are not limited to, a cinnamic acid derivative, sinapinic acid and dihydroxybenzoic acid.

### BRIEF DESCRIPTION OF THE DRAWINGS

FIG. 1 depicts a probe comprising a substrate 101 and discontinuous spots of adsorbents 102. The probe is removably insertable into a gas phase ion spectrometer. Each spot is addressable by an energy source for desorbing the analyte.

FIG. 2 depicts the detection of a protein (horseradish peroxidase) differentially present in two samples, both before and after fractionation and detection by the methods of this invention. Bovine serum and bovine serum spiked with horseradish peroxidase were first detected directly on an adsorbent surface by SELDI. The top panels depict mass spectra traces and show that the marker is not detectable in the spiked sample. The arrow in the panel second from the top indicates where the mass of HRP. Then, both samples were subjected to fractionation by size exclusion spin chromatography followed by strong anion exchange spin chromatography. The samples were then detected on an adsorbent surface by SELDI (see lower two panels). In this case, the marker is clearly detectable in the spiked sample (see arrow indicating HRP), but not in the un-spiked sample.

FIG. 3 depicts detection of analytes from a tryptic digest of horse myoglobin. The top panel depicts a mass spectrum of the analytes in the digest that were detected using MALDI carried out on a Gold array. The lower panel depicts a mass spectrum of the analytes as analyzed using a Reverse Phase H4 ProteinChip® to carry out concentration SELDI.

### DESCRIPTION OF THE SPECIFIC EMBODIMENTS

I. Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

“Substrate” or “probe substrate” refers to a solid phase onto which an adsorbent can be provided (e.g., by attachment, deposition, etc.).

“Surface” refers to the exterior or upper boundary of a probe substrate.

“Strip” refers to a long narrow piece of a material that is substantially flat or planar.

“Plate” refers to a thin piece of material that is substantially flat or planar, and it can be in any suitable shape (e.g., rectangular, square, oblong, circular, etc.).

“Adsorbent” refers to any material capable of adsorbing an analyte. The term “adsorbent” is used herein to refer both to a single material (“monoplex adsorbent”) (e.g., a compound or functional group) to which the analyte is exposed, and to a plurality of different materials (“multiplex adsorbent”) to which the analyte is exposed. The adsorbent materials in a multiplex adsorbent are referred to as “adsorbent species.” For example, an addressable location on a probe substrate can comprise a multiplex adsorbent characterized by many different adsorbent species (e.g., anion exchange materials, metal chelators, or antibodies), having different binding characteristics. Substrate material itself can also contribute to adsorbing an analyte and may be considered part of an “adsorbent.”

“Adsorbent surface” refers to a sample presenting surface of a probe to which an adsorbent is bound.

“Substantially flat” refers to a substrate having the major surfaces essentially parallel and distinctly greater than the minor surfaces (e.g. a strip or a plate).

“Adsorption” or “retention” refers to the detectable binding between an absorbent and an analyte either before or after washing with an eluant (selectivity threshold modifier) or a washing solution.

“Eluant” or “washing solution” refers to an agent that can be used to mediate adsorption of an analyte to an adsorbent. Eluants and washing solutions also are referred to as “selectivity threshold modifiers.” Eluants and washing solutions can be used to wash and remove unbound materials from the probe substrate surface.

“Specific binding” refers to binding that is mediated primarily by the basis of attraction of an adsorbent for a designated analyte. For example, the basis of attraction of an anionic exchange adsorbent for an analyte is the electrostatic attraction between positive and negative charges. Therefore, anionic exchange adsorbents engage in specific binding with negatively charged species. The basis for attraction of a hydrophilic adsorbent for an analyte is hydrogen bonding. Therefore, hydrophilic adsorbents engage in specific binding with electrically polar species, etc.

“Resolve,” “resolution,” or “resolution of analyte” refers to the detection of at least one analyte in a sample. Resolution includes the detection and differentiation of a plurality of analytes in a sample by separation and subsequent differential detection. Resolution does not require the complete separation of an analyte from all other analytes in a mixture. Rather, any separation that allows the distinction between at least two analytes suffices.

“Probe” refers to a device that, when positionally engaged in an interrogatable relationship to an ionization source, e.g., a laser desorption/ionization source, and in concurrent communication at atmospheric or subatmospheric pressure with a detector of a gas phase ion spectrometer, can be used to introduce ions derived from an analyte into the spectrometer. As used herein, the “probe” is typically reversibly engageable (e.g., removably insertable) with a probe interface that positions the probe in an interrogatable relationship with the ionization source and in communication with the detector. A probe will generally comprise a substrate comprising a sample presenting surface on which an analyte is presented to the ionization source.

“Ionization source” refers to a device that directs ionizing energy to a sample presenting surface of a probe to desorb and ionize analytes from the probe surface into the gas phase. The preferred ionization source is a laser (used in laser desorption/ionization), in particular, nitrogen lasers, Nd-Yag lasers and other pulsed laser sources. Other ionization sources include fast atoms (used in fast atom bombardment), plasma energy (used in plasma desorption) and primary ions generating secondary ions (used in secondary ion mass spectrometry).

“Gas phase ion spectrometer” refers to an apparatus that detects gas phase ions. In the context of this invention, gas phase ion spectrometers include an ionization source used to generate the gas phase ions. Gas phase ion spectrometers include, for example, mass spectrometers, ion mobility spectrometers, and total ion current measuring devices.

“Gas phase ion spectrometry” refers to a method comprising employing an ionization source to generate gas phase ions from an analyte presented on a sample presenting surface of a probe and detecting the gas phase ions with a gas phase ion spectrometer.

“Mass spectrometer” refers to a gas phase ion spectrometer that measures a parameter which can be translated into mass-to-charge ratios of gas phase ions. Mass spectrometers generally include an inlet system, an ionization source, an ion optic assembly, a mass analyzer, and a detector. Examples of mass spectrometers are time-of-flight, magnetic sector, quadrapole filter, ion trap, ion cyclotron resonance, electrostatic sector analyzer and hybrids of these.

“Mass spectrometry” refers to a method comprising employing an ionization source to generate gas phase ions from an analyte presented on a sample presenting surface of a probe and detecting the gas phase ions with a mass spectrometer.

“Laser desorption mass spectrometer” refers to a mass spectrometer which uses laser as a means to desorb, volatilize and ionize an analyte.

“Detect” refers to identifying the presence, absence or amount of the object to be detected.

“Biological material” refers to any material derived from an organism, organ, tissue, cell or virus. This includes biological fluids such as saliva, blood, urine, lymphatic fluid, prostatic fluid, seminal fluid, milk, etc., as well as extracts of any of these, e.g., cell extracts, cell culture medium, fractionated samples, etc.

“Bioorganic molecule” refers to an organic molecule typically made by living organisms. This includes, for example, molecules comprising nucleotides, amino acids, sugars, fatty acids, steroids, nucleic acids, polypeptides, carbohydrates, lipids, combinations of these (e.g., glycoproteins, ribonucleoproteins, lipoproteins).

“Energy absorbing molecule” or “EAM” refers to a molecule that absorbs energy from an energy source in a mass spectrometer thereby enabling desorption of analyte from a probe surface. Energy absorbing molecules used in MALDI are frequently referred to as “matrix.” Cinnamic acid derivatives, sinapinic acid and dihydroxybenzoic acid are frequently used as energy absorbing molecules in laser desorption of bioorganic molecules. See U.S. Pat. No. 5,719,060 (Hutchens & Yip) for a further description of energy absorbing molecules.

“Binding characteristic” refers to a chemical and physical feature that dictates the attraction of an adsorbent for an analyte. Two adsorbents have different binding characteristics if, under the same elution conditions, the adsorbents bind the same analyte with different degrees of affinity. Binding characteristics include, for example, degree of salt-promoted interaction, degree of hydrophobic interaction, degree of hydrophilic interaction, degree of electrostatic interaction, and others described herein.

“Elution characteristic” refers to a physical or chemical characteristic of an eluant that contributes to its ability to affect or modify adsorption of an analyte to an adsorbent of an adsorption surface. Two eluants have different elution characteristics if, when put in contact with an analyte and adsorbent, the degree of affinity of the analyte for the adsorbent differs. Elution characteristics include, for example, pH, ionic strength, degree of chaotropism, detergent strength, and temperature.

II. SELDI Methods

A. SELDI and MALDI

SELDI differs from MALDI in the participation of the sample presenting surface in the desorption/ionization process. In MALDI, the sample presenting surface plays no role in this process—the analytes detected reflect those mixed with and trapped within the matrix material. In SELDI, the sample presenting surface comprises adsorbent molecules that exhibit some level of affinity for certain classes of analyte molecules. Thus, after application of energy absorbing molecules (e.g., “matrix”) to the surface and impingement by an energy source, the specific analyte molecules detected depend, in part, upon the interaction between the adsorbent and the analyte molecules. Thus, different populations of molecules are detected when performing SELDI and MALDI.

Three different versions of SELDI are described here: “Retentate Chromatography,” “No-wash SELDI” and “Concentration SELDI.”

B. Retentate Chromatography

Retentate chromatography generally proceeds as follows. A liquid sample comprising bioorganic analytes is applied to a sample presenting surface which comprises an adsorbent, e.g., a spot on the surface of a biochip. The adsorbent possesses various levels of affinity for classes of molecular analytes based on chemical characteristics. For example, a hydrophilic adsorbent has affinity for hydrophilic biomolecules. The sample is allowed to reach binding equilibrium with the adsorbent. In reaching binding equilibrium, the analytes bind to the adsorbent or remain in solution based on their level of attraction to the adsorbent.

The particular binding equilibrium struck by a class of molecules is, of course, mediated by the binding constant of that molecule for the adsorbent: The smaller the binding constant, the tighter the binding between the molecule and the adsorbent and the more likely the molecule is to be bound to the adsorbent than to be in solution. Molecules that are non-attracted or repelled by the adsorbent are likely to be free in solution, with few, if any, being bound to the adsorbent.

After allowing molecules to bind to the adsorbent, the liquid and unbound molecules are removed from the spot, e.g., by pipetting. What is left on the spot are molecules bound to the adsorbent and probably some unbound molecules not completely removed with the liquid. Thus, most of the unbound molecules are removed with the removal of the liquid.

Then, a wash solution is applied to the spot. Generally, the wash solution has a different elution characteristic than the liquid in which the sample was applied. For example, the wash solution may have a different pH or salt concentration than that of the original sample. In the wash step, the analytes may reach a new equilibrium between being bound and remaining in solution. For example, if the stringency of the wash is greater than the stringency of the liquid in which the sample was applied, weakly bound molecules may be released into solution. This wash solution is now removed from the spot, taking with it unbound molecules. This includes both biomolecular analytes as well as inorganic molecules such as salts. Thus, the wash can function as a desalting step, particularly if the wash solution has similar characteristics to the solution in which the sample was applied.

After the wash step, the population of analyte molecules on the surface is significantly different from that of the population in the original sample. In particular, compared with molecules in the original sample, the ratio of molecules remaining on the adsorbent is heavily skewed toward those with particular affinity for the adsorbent, and molecules that have little or no affinity for the adsorbent have been removed by washing.

At this point, the analytes remaining on the surface are usually allowed to dry, although this step is not necessary. The analytes now exist as a layer on the spot.

Energy absorbing molecules, sometimes called matrix, are applied to the probe surface to facilitate desorption/ionization. Usually, the energy absorbing molecules are applied to the spot and allowed to dry. However, in some embodiments, the energy absorbing molecules are applied to the surface of the probe before application of the sample. (One version of this embodiment is called “SEND.” See U.S. Pat. No. 6,124,137 (Hutchens and Yip).) The analytes can now be examined by gas phase ion spectrometry, preferably laser desorption/ionization mass spectrometry; the interaction between the matrix and the surface layer of analytes at the interface between the two enabling desorption and ionization of biomolecular analytes at this interface.

C. No-wash SELDI

Another method, “No-wash SELDI,” includes the following steps: A liquid sample comprising bioorganic analytes is applied to a sample presenting surface which comprises an adsorbent, e.g., a spot on the surface of a biochip. The sample is allowed to reach equilibrium with the adsorbent. After allowing molecules to bind to the adsorbent, the liquid is removed from the spot, e.g., by pipetting. The bound molecules (and probably some unbound molecules) remain on the substrate and most of the unbound molecules are removed with the liquid. In this method, no wash solution is applied to the spot. Because excess sample is removed after reaching equilibrium, and without a wash step, the population of molecules on the adsorbent spot differs from the population of molecules in the applied sample and from the population remaining on the spot in retentate chromatography. As in retentate chromatography, the population on the adsorbent spot is richer in molecules having affinity for the adsorbent, compared with the originally applied sample. However, the population also differs from that remaining in retentate chromatography because un-bound, non-specifically bound or weakly bound molecules, which are washed away in retentate chromatography, remain on the sample presenting surface. This includes both biomolecular and inorganic species, such as salts.

At this point, the analytes remaining on the surface are usually allowed to dry, although this step is not necessary. Then, an energy absorbing material (e.g., a cinnamic acid derivative, sinapinic acid and dihydroxybenzoic acid) is applied to the spot and allowed to dry. Then the analytes can be examined by gas phase ion spectrometry, preferably laser desorption/ionization mass spectrometry.

D. Concentration SELDI

In another method, referred to as “Concentration SELDI,” the steps proceed as follows. A liquid sample comprising bioorganic analytes is applied to a sample presenting surface which comprises an adsorbent, e.g., a spot on the surface of a biochip. The analytes in the sample are now concentrated on the adsorbent surface. Concentration proceeds by reducing the volume of the sample (e.g., by evaporation) so that the amount of analyte per unit volume increases. In contrast to No-wash SELDI or Retentate chromatography, sample liquid and unbound analytes are not removed together from the adsorbent surface. The analytes in the sample are preferably concentrated essentially to dryness. However, concentration can proceed at least 2-fold, at least 10-fold, at least 100-fold, or at least 1000 fold before application of energy absorbing molecules. Because the volume of the sample decreases steadily, the analytes never reach a stable binding equilibrium in solution. By concentrating the analytes on the adsorbent, all the analytes in the sample remain on the surface, regardless of their attraction to the adsorbent. (Certain volatile analytes may be lost in an evaporation process.) Thus, there is both specific binding (i.e., adsorbent mediated) and non-specific binding of analytes to the adsorbent surface. Then, an energy absorbing material is applied to the spot and allowed to dry. Then the analytes can be examined by gas phase ion spectrometry, preferably laser desorption/ionization mass spectrometry.

In this case, while the population of analytes on the surface of the chip reflects the population of analytes in the applied sample, a fraction of the analytes remain bound to the chip surface even after the application of an energy absorbing material. Thus, the analyte fraction incorporated into the energy absorbing material represents the fraction of analytes which have low binding affinity for the adsorbent surface under the conditions present when the solution of energy absorbing material is deposited on the adsorbent surface. This contrasts with MALDI, in which the analyte sample is mixed directly with matrix material. The result is that signal strength from an analyte in each case is different, and signals from certain molecules, which are not detectable or distinguishable in MALDI can be detected in concentration SELDI (see, e.g., Example 3). Thus, concentration SELDI can provide a more sensitive assay for the presence of bioorganic molecules in a sample than MALDI.

III. Probes with Chromatographic Surfaces

The methods of this invention are performed on probes adapted for gas phase ion spectrometers. The probes comprise a substrate having a surface and, attached to the surface, an adsorbent that can selectively bind analytes.

A. Substrates

The probes of this invention are removably insertable into a gas phase ion spectrometer. For example, a substrate can be in the form of a strip with adsorbents on its surface. The probe can be in any shape as long as it is removably insertable into a gas phase ion spectrometer. This can include, for example rectangular or circular probes.

The probe can also be adapted for use with inlet systems and detectors of a gas phase ion spectrometer. For example, the probe can be adapted for mounting in a horizontally, vertically and/or rotationally translatable carriage that moves the probe to a successive position without requiring repositioning of the probe by hand.

The probe substrate is preferably made of a material that is capable of supporting adsorbents. For example, the probe substrate material can include, but is not limited to, insulating materials (e.g., glass, ceramic), semi-insulating materials (e.g., silicon wafers), or electrically conducting materials (e.g., metals, such as nickel, brass, steel, aluminum, gold, or electrically conductive polymers), organic polymers, or any combinations thereof.

The probe substrate surface can be conditioned to bind analytes. For example, in one embodiment, the surface of the probe substrate can be conditioned (e.g., chemically or mechanically such as roughening) to place adsorbents on the surface. The adsorbent comprises functional groups for binding with an analyte. In some embodiments, the substrate material itself can also contribute to adsorbent properties and may be considered part of an “adsorbent.”

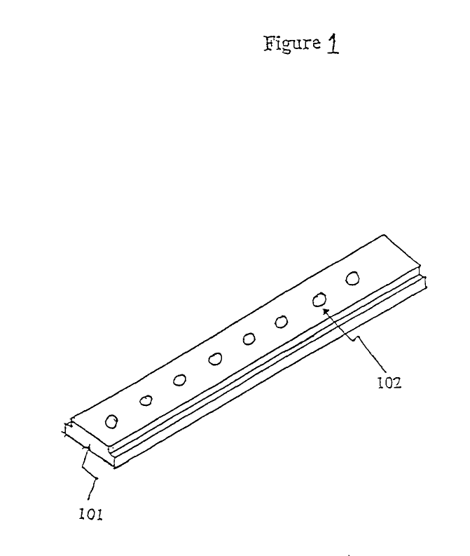

Adsorbents can be placed on the probe substrate in continuous or discontinuous patterns. If continuous, one or more adsorbents can be placed on the substrate surface. If multiple types of adsorbents are used, the substrate surface can be coated such that one or more binding characteristics vary in one or two-dimensional gradient. If discontinuous, plural adsorbents can be placed in predetermined addressable locations (e.g., addressable by a laser beam of a mass spectrometer) on the substrate surface. The addressable locations can be arranged in any pattern, but are preferably in regular pattern, such as lines, orthogonal arrays, or regular curves (e.g., circles). Each addressable location may comprise the same or different adsorbent. In FIG. 1, a probe comprising discontinuous spots of adsorbents is shown. The spots are “addressable” in that during mass spectrometry, an energy source, such as a laser, is directed to, or “addresses” the spot to desorb the analyte.

The probes can be produced using any suitable methods depending on the selection of substrate materials and/or adsorbents. For example, the surface of a metal substrate can be coated with a material that allows derivitization of the metal surface. More specifically, a metal surface can be coated with silicon oxide, titanium oxide or gold. Then surface can be derivatized with a bifunctional linker, one end of which can covalently bind with a functional group on the surface and the other end of which can be further derivatized with groups that function as an adsorbent. In another example, a porous silicon surface generated from crystalline silicon can be chemically modified to include adsorbents for binding analytes. In yet another example, adsorbents with a hydrogel backbone can be formed directly on the substrate surface by in situ polymerizing a monomer solution which comprises, e.g., substituted acrylamide monomers, substituted acrylate monomers, or derivatives thereof comprising a functional group of choice as an adsorbent.

Probes suitable for use in the invention also are described in, e.g., U.S. Pat. No. 5,617,060 (Hutchens and Yip) and WO 98/59360 (Hutchens and Yip).

B. Adsorbents

Adsorbents are the materials that bind analytes. They are attached to the surface of the substrates that form the probes. A plurality of adsorbents can be employed in the methods of this invention. Different adsorbents can exhibit grossly different binding characteristics, somewhat different binding characteristics, or subtly different binding characteristics.

Adsorbents which exhibit grossly different binding characteristics typically differ in their bases of attraction or mode of interaction. The basis of attraction is generally a function of chemical or biological molecular recognition. Bases for attraction between an adsorbent and an analyte include, for example, (1) a salt-promoted interaction, e.g., hydrophobic interactions, thiophilic interactions, and immobilized dye interactions; (2) hydrogen bonding and/or van der Waals forces interactions and charge transfer interactions, such as in the case of a hydrophilic interactions; (3) electrostatic interactions, such as an ionic charge interaction, particularly positive or negative ionic charge interactions; (4) the ability of the analyte to form coordinate covalent bonds (i.e., coordination complex formation) with a metal ion on the adsorbent; or combinations of two or more of the foregoing modes of interaction. That is, the adsorbent can exhibit two or more bases of attraction, and thus be known as a “mixed functionality” adsorbent.

1. Salt-promoted Interaction Adsorbents

Adsorbents which are useful for observing salt-promoted interactions include hydrophobic interaction adsorbents.

Examples of hydrophobic interaction adsorbents include matrices having aliphatic hydrocarbons, specifically C1-C18 aliphatic hydrocarbons; and matrices having aromatic hydrocarbon functional groups such as phenyl groups.

Another adsorbent useful for observing salt-promoted interactions includes thiophilic interaction adsorbents, such as for example T-GEL® which is one type of thiophilic adsorbent commercially available from Pierce, Rockford, Illinois.

A third adsorbent which involves salt-promoted ionic interactions and also hydrophobic interactions includes immobilized dye interaction adsorbents. Immobilized dye interaction adsorbents include matrices of immobilized dyes such as for example CIBACHRON™ blue available from Pharmacia Biotech, Piscataway, N.J.

a) Reverse Phase Adsorbent—Aliphatic Hydrocarbon

One useful reverse phase adsorbent is a hydrophobic (C16) H4 chip, available from Ciphergen Biosystems, Inc. (Palo Alto, Calif.). The hydrophobic H4 chip comprises C16 chains immobilized on top of silicon oxide (SiO₂) as the adsorbent on the substrate surface.

2. Hydrophilic Interaction Adsorbents

Adsorbents which are useful for observing hydrogen bonding and/or van der Waals forces on the basis of hydrophilic interactions include surfaces comprising normal phase adsorbents such as silicon-oxide (e.g., glass). The normal phase or silicon-oxide surface acts as a functional group. In addition, adsorbents comprising surfaces modified with hydrophilic polymers such as polyethylene glycol, dextran, agarose, or cellulose can also function as hydrophilic interaction adsorbents. Most proteins will bind hydrophilic interaction adsorbents because of a group or combination of amino acid residues (i.e., hydrophilic amino acid residues) that bind through hydrophilic interactions involving hydrogen bonding or van der Waals forces.

a) Normal Phase Adsorbent—Silicon Oxide

One useful hydrophilic adsorbent is a Normal Phase chip, available from Ciphergen Biosystems, Inc. (Palo Alto, Calif.). The normal phase chip comprises silicon oxide (SiO₂) as the adsorbent on the substrate surface. Silicon oxide can be applied to the surface by any of a number of well known methods. These methods include, for example, vapor deposition, e.g., sputter coating. A preferred thickness for such a probe is about 9000 Angstroms.

3. Electrostatic Interaction Adsorbents

Adsorbents which are useful for observing electrostatic or ionic charge interactions include anionic adsorbents such as, for example, matrices of sulfate anions (i.e., SO₃⁻) and matrices of carboxylate anions (i.e., COO⁻) or phosphate anions (OPO₃⁻). Matrices having sulfate anions are permanent negatively charged. However, matrices having carboxylate anions have a negative charge only at a pH above their pKa. At a pH below the pKa, the matrices exhibit a substantially neutral charge. Suitable anionic adsorbents also include anionic adsorbents which are matrices having a combination of sulfate and carboxylate anions and phosphate anions.

Other adsorbents which are useful for observing electrostatic or ionic charge interactions include cationic adsorbents. Specific examples of cationic adsorbents include matrices of secondary, tertiary or quaternary amines. Quaternary amines are permanently positively charged. However, secondary and tertiary amines have charges that are pH dependent. At a pH below the pKa, secondary and tertiary amines are positively charged, and at a pH above their pKa, they are negatively charged. Suitable cationic adsorbents also include cationic adsorbents which are matrices having combinations of different secondary, tertiary, and quaternary amines.

In the case of ionic interaction adsorbents (both anionic and cationic) it is often desirable to use a mixed mode ionic adsorbent containing both anions and cations. Such adsorbents provide a continuous buffering capacity as a function of pH.

Still other adsorbents which are useful for observing electrostatic interactions include dipole-dipole interaction adsorbents in which the interactions are electrostatic but no formal charge or titratable protein donor or acceptor is involved.

a) Anionic Adsorbent

One useful adsorbent is an anionic adsorbent such as the SAX1 ProteinChip® made by Ciphergen Biosystems, Inc. in Palo Alto, Calif. The SAX1 protein chips are fabricated from SiO₂ coated aluminum substrates. In the process, a suspension of quaternary ammonium polystryenemicrospheres in distilled water is deposited onto the surface of the chip (1 mL/spot, two times). After air drying (room temperature, 5 minutes), the chip is rinsed with deionized water and air dried again (room temperature, 5 minutes).

b) Cationic Adsorbent

One useful adsorbent is an cationic adsorbent such as the SCX1 ProteinChip® made by Ciphergen Biosystems, Inc. in Palo Alto, Calif. The SCX1 protein chips are fabricated from SiO₂ coated aluminum substrates. In the process, a suspension of sulfonate polystyrene microspheres in distilled water is deposited onto the surface of the chip (1 mL/spot, two times). After air drying (room temperature, 5 minutes), the chip is rinsed with deionized water and air dried again (room temperature, 5 minutes).

4. Coordinate Covalent Interaction Adsorbents

Adsorbents which are useful for observing the ability to form coordinate covalent bonds with metal ions include matrices bearing, for example, divalent and trivalent metal ions. Matrices of immobilized metal ion chelators provide immobilized synthetic organic molecules that have one or more electron donor groups which form the basis of coordinate covalent interactions with transition metal ions. The primary electron donor groups functioning as immobilized metal ion chelators include oxygen, nitrogen, and sulfur. The metal ions are bound to the immobilized metal ion chelators resulting in a metal ion complex having some number of remaining sites for interaction with electron donor groups on the analyte. Suitable metal ions include in general transition metal ions such as copper, nickel, cobalt, zinc, iron, and other metal ions such as aluminum and calcium.

a) Nickel Chelate Adsorbent

Another useful adsorbent is a metal chelate adsorbent such as the IMAC3 (Immobilized Metal Affinity Capture, nitrilotriacetic acid on surface) chip, also available from Ciphergen Biosystems, Inc. The chips are produced as follows: 5-Methacylamido-2-(N,N-biscarboxymethaylamino)pentanoic acid (7.5 wt %), Acryloyltri-(hydroxymethyl)methylamine (7.5 wt %) and N,N′-methylenebisacrylamide (0.4 wt %) are photo-polymerized using—(−)riboflavin (0.02 wt %) as a photo-initiator. The monomer solution is deposited onto a rough etched, glass coated substrate (0.4 mL, twice) and irradiated for 5 minutes with a near UV exposure system (Hg short arc lamp, 20 mW/cm2 at 365 nm). The surface is washed with a solution of sodium chloride (1 M) and then washed twice with deionized water.

The IMAC3 with Ni(II) is activated as follows. The surface is treated with a solution of NiSO₄ (50 mM, 10 mL/spot) and mixed on a high frequency mixer for 10 minutes. After removing the NiSO₄ solution, the treatment process is repeated. Finally, the surface is washed with a stream of deionized water (15 sec/chip).

5. Enzyme-active Site Interaction Adsorbents

Adsorbents which are useful for observing enzyme-active site binding interactions include proteases (such as trypsin), phosphatases, kinases, and nucleases. The interaction is a sequence-specific interaction of the enzyme binding site on the analyte (typically a biopolymer) with the catalytic binding site on the enzyme.

6. Reversible Covalent Interaction Adsorbents

Adsorbents which are useful for observing reversible covalent interactions include disulfide exchange interaction adsorbents. Disulfide exchange interaction adsorbents include adsorbents comprising immobilized sulfhydryl groups, e.g., mercaptoethanol or immobilized dithiothrietol. The interaction is based upon the formation of covalent disulfide bonds between the adsorbent and solvent exposed cysteine residues on the analyte. Such adsorbents bind proteins or peptides having cysteine residues and nucleic acids including bases modified to contain reduced sulfur compounds.

7. Glycoprotein Interaction Adsorbents

Adsorbents which are useful for observing glycoprotein interactions include glycoprotein interaction adsorbents such as adsorbents having immobilize lectins (i.e., proteins bearing oligosaccharides) therein, an example of which is CONCONAVALIN™, which is commercially available from Pharmacia Biotech of Piscataway, N.J. Such adsorbents function on the basis of the interaction involving molecular recognition of carbohydrate moieties on macromolecules.

8. Biospecific Interaction Adsorbents

Adsorbents which are useful for observing biospecific interactions are generically termed “biospecific affinity adsorbents.” Adsorption is considered biospecific if it is selective and the affinity (equilibrium dissociation constant, Kd) is at least 10⁻³ M to (e.g., 10⁻⁵ M, 10⁻⁷ M, 10⁻⁹ M). Examples of biospecific affinity adsorbents include any adsorbent which specifically interacts with and binds a particular biomolecule. Biospecific affinity adsorbents include for example, immobilized antibodies which bind to antigens; immobilized DNA which binds to DNA binding proteins, DNA, and RNA; immobilized substrates or inhibitors which bind to proteins and enzymes; immobilized drugs which bind to drug binding proteins; immobilized ligands which bind to receptors; immobilized receptors which bind to ligands; immobilized RNA which binds to DNA and RNA binding proteins; immobilized avidin or streptavidin which bind biotin and biotinylated molecules; immobilized phospholipid membranes and vesicles which bind lipid-binding proteins.

IV. Sample Preparation

The samples used in this invention can be from any biological material source. This includes body fluids such as blood, serum, saliva, urine, prostatic fluid, seminal fluid, etc. It also includes extracts from biological samples, such as cell lysates, cell culture medium, etc. Preferably, the sample is in liquid form and solid material has been removed.

The sample can be applied directly to the adsorbent on the probe surface. Alternatively, the sample can be fractionated before use. Fractionation is useful because it decreases the complexity of the analytes in the sample. The sample can be fractionated by any known method useful for separating biomolecules. Separation can be based on size by, for example, gel exclusion chromatography, gel electrophoresis and membrane dialysis or ultracentifugation. HPLC is a useful method. Separation also can be based on charges carried by analytes, such as anion or cation exchange chromatography, or based on hydrophobicity, such as C1-18 resins, or by affinity methods such as immunoaffinity, immobilized metals, DNA, dyes. Other methods of fractionation include, for example, crystallization and precipitation.

In another embodiment, these methods can be combined. For example in a preferred embodiment, the sample is fractionated by size exclusion chromatography followed by anion or cation exchange chromatography.

The sample is contacted with the adsorbent on the probe substrate. Then the sample is allowed to dry on the adsorbent. This results in both specific and nonspecific adsorption of the analytes in the sample by the adsorbent, without washing away analytes that are not bound to the adsorbent. Generally, a volume of sample containing from a few attomoles to 100 picomoles of analyte in about 1 μl to 500 μl is sufficient for binding to the adsorbent.

After the analyte is applied to the probe and dried, it is detected using gas phase ion spectrometry. Analytes or other substances bound to the adsorbents on the probes can be analyzed using a gas phase ion spectrometer. The quantity and characteristics of the analyte can be determined using gas phase ion spectrometry. Other substances in addition to the analyte of interest can also be detected by gas phase ion spectrometry, e.g., laser desorption ionization mass spectrometry.

V. Gas Phase Ion Spectrometry

A. Gas Phase Ion Spectrometry Detection

In a preferred embodiment, the analyte is detected by laser desorption mass spectrometry. Laser desorption mass spectrometry involves presenting the analytes on a probe surface to a laser energy source that desorbs the analyte from the probe surface and ionizes it. The desorbed and ionized analytes are then detected. An energy absorbing molecule (e.g., in solution) can then be applied to analytes or other substances bound on the probe substrate surface. Spraying, pipetting, or dipping can be used.

In one embodiment, a mass spectrometer can be used to detect analytes on the probe. In a typical mass spectrometer, a probe with an analyte is introduced into an inlet system of the mass spectrometer. The analyte is then desorbed by a desorption source such as a laser, fast atom bombardment, or high energy plasma. The generated desorbed, volatilized species consist of preformed ions or neutrals which are ionized as a direct consequence of the desorption event. Generated ions are collected by an ion optic assembly, and then a mass analyzer disperses and analyzes the passing ions. The ions exiting the mass analyzer are detected by a detector. The detector then translates information of the detected ions into mass-to-charge ratios. Detection of the presence of an analyte or other substances will typically involve detection of signal intensity. This, in turn, can reflect the quantity and character of an analyte bound to the probe.

In a preferred embodiment, a laser desorption time-of-flight mass spectrometer is used with the probe of the present invention. In laser desorption mass spectrometry, a probe with a bound analyte is introduced into an inlet system. The analyte is desorbed and ionized into the gas phase by laser from the ionization source. The ions generated are collected by an ion optic assembly, and then in a time-of-flight mass analyzer, ions are accelerated through a short high voltage field and let drift into a high vacuum chamber. At the far end of the high vacuum chamber, the accelerated ions strike a sensitive detector surface at a different time. Since the time-of-flight is a function of the mass of the ions, the elapsed time between ion formation and ion detector impact can be used to identify the presence or absence of molecules of specific mass to charge ratio. As any person skilled in the art understands, any of these components of the laser desorption time-of-flight mass spectrometer can be combined with other components described herein in the assembly of mass spectrometer that employs various means of desorption, acceleration, detection, measurement of time, etc.

A typical laser desorption mass spectrometer can employ a nitrogen laser at 337.1 mn. A useful pulse width is 4 nanoseconds. Generally, power output of about 1-25 μJ is used.

In another embodiment, an ion mobility spectrometer can be used to detect and characterize an analyte. The principle of ion mobility spectrometry is based on different mobility of ions. Specifically, ions of a sample produced by ionization move at different rates, due to their difference in, e.g., mass, charge, or shape, through a gas containing tube under the influence of an electric field. The ions (typically in the form of a current) are registered at the detector which can then be used to identify an analyte or other substances in the sample. One advantage of ion mobility spectrometry is that it can operate at atmospheric pressure.

In yet another embodiment, a total ion current measuring device can be used to detect and characterize analytes. This device can be used when the probe has a surface chemistry that allows only a single type of analyte to be bound. When a single type of analyte is bound on the probe, the total current generated from the ionized analyte reflects the nature of the analyte. The total ion current produced by the analyte can then be compared to stored total ion current of known compounds. Characteristics of the analyte can then be determined.

B. Data Analysis

Data generated by desorption and detection of analytes can be analyzed with the use of a programmable digital computer. The computer program generally contains a readable medium that stores codes. Certain code can be devoted to memory that includes the location of each feature on a probe, the identity of the adsorbent at that feature and the elution conditions used to wash the adsorbent. Using this information, the program can then identify the set of features on the probe defining certain selectivity characteristics (e.g., types of adsorbent and eluants used). The computer also contains code that receives as input, data on the strength of the signal at various molecular masses received from a particular addressable location on the probe. This data can indicate the number of analytes detected, optionally including the strength of the signal and the determined molecular mass for each analyte detected.

Data analysis can include the steps of determining signal strength (e.g., height of peaks) of an analyte detected and removing “outerliers” (data deviating from a predetermined statistical distribution). For example, the observed peaks can be normalized, a process whereby the height of each peak relative to some reference is calculated. For example, a reference can be background noise generated by instrument and chemicals (e.g., energy absorbing molecule) which is set as zero in the scale. Then the signal strength detected for each analyte or other substances can be displayed in the form of relative intensities in the scale desired (e.g., 100). Alternatively, a standard may be admitted with the sample so that a peak from the standard can be used as a reference to calculate relative intensities of the signals observed for each analyte or other analytes detected.

The computer can transform the resulting data into various formats for displaying. In one format, referred to as “spectrum view or retentate map,” a standard spectral view can be displayed, wherein the view depicts the quantity of analyte reaching the detector at each particular molecular weight. In another format, referred to as “peak map,” only the peak height and mass information are retained from the spectrum view, yielding a cleaner image and enabling analytes with nearly identical molecular weights to be more easily seen. In yet another format, referred to as “gel view,” each mass from the peak view can be converted into a grayscale image based on the height of each peak, resulting in an appearance similar to bands on electrophoretic gels. In yet another format, referred to as “3-D overlays,” several spectra can be overlaid to study subtle changes in relative peak heights. In yet another format, referred to as “difference map view,” two or more spectra can be compared, conveniently highlighting unique analytes and analytes which are up- or down-regulated between samples. Analyte profiles (spectra) from any two samples may be compared visually.

### EXAMPLES

### Example 1

### Detection Of A Marker, Horseradish Peroxidase, In Bovine Serum Using Concentration SELDI

Proteins in the serum samples of different individuals may be expressed differently. ProteinChip® technology together with protein fractionation method are used together to detect proteins that are up-regulated or down-regulated in these samples.

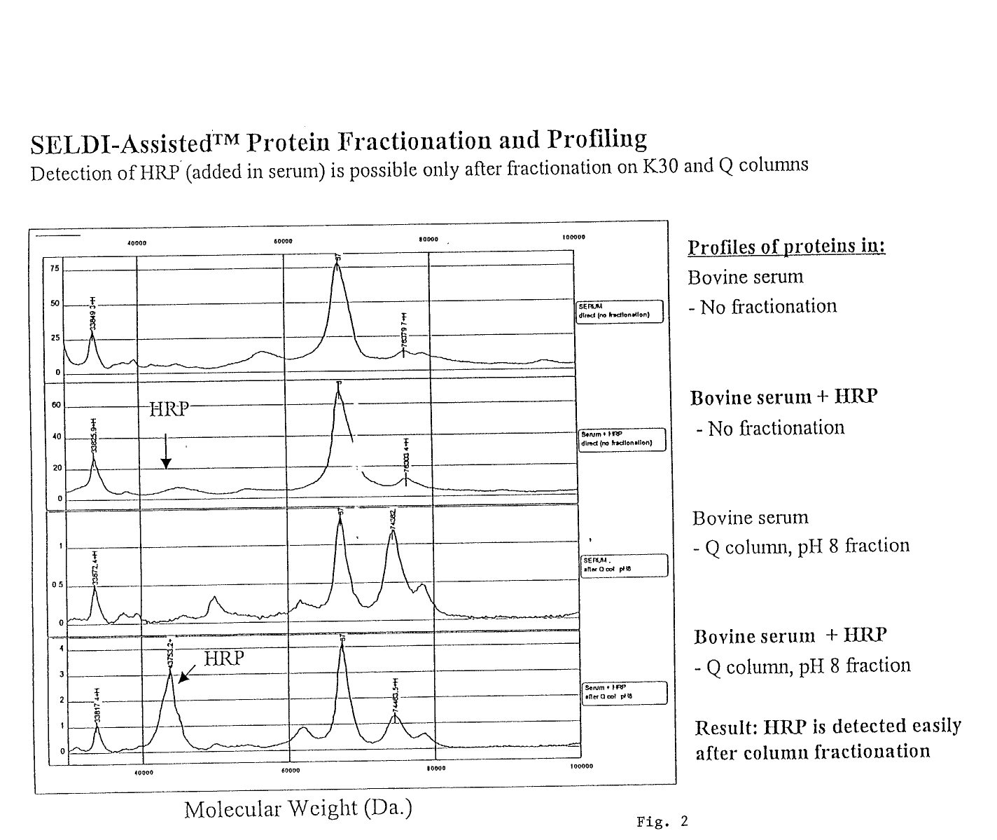

For the experiment, bovine serum with and without an added protein marker (horseradish peroxidase—HRP) at low concentration (less than 0.5% total proteins) were used for profiling. The mass spectra profiles of these two samples before protein fractionation are compared for the detection of HRP (see FIG. 2, top two panels).

The two samples are fractionated on a K30 size-selection spin column (which separates proteins below 15 kDa from those above 30 kDa) and followed by fractionation on a Q anion-exchanger (a strong anion exchanger) spin column. These spin columns are commercially available from Ciphergen Biosystems, Inc. Spin columns performing similar functions are well known in the art and commercially available from other sources. Proteins in the column fractions are profiled using SELDI for the detection of HRP by comparison of two samples. The pH 8 fraction of the Q column for serum sample with added protein marker shows the detection of HRP (peak at 43 kDa) (see FIG. 2, fourth panel from the top) as compared to sample without added marker (see FIG. 2, third panel from the top). The protocol was substantially as described below.

A. Protein fractionation by K30 Size-selection Spin Columns:

The serum or lysates (˜5 mg/ml proteins or higher) was adjusted to have 0.4 M NaCl and 0.01% (v/v) Triton X-100 using SM NaCl and 1% Triton stock solutions. About 10% dilution of the original sample is ideal. Mix well and incubate on ice for 20 min.

An aliquot (30 μL) of sample was applied to a size exclusion spin column that was equilibrated in 20 mM Tris-HCl, pH 9.0. Follow the following protocol for size selection Spin Column:

1. Storage Buffer Exchange:

1. Break the outlet cap of the spin column. Insert the column into 1.5-ml tube (2-ml tube is even better).

2. Open the top cap of the spin column. Let the storage buffer drain into the tube by gravity. If the storage buffer does not come down easily, tap the column and tube unit on a hard surface several times, or centrifuge at 3000 rpm for a few seconds.

3. Let the storage buffer (e.g., PBS) drain out by gravity until no more drops come out. Empty the tube.

4. Apply 0.75 ml of desired storage buffer, e.g., 20 mM Tris-HCl, pH 9.0, to the column and let it flow through the column matrix by gravity. Repeat this step two more times so that at least three column volumes of new buffer have passed through.

2. Protein Purification Protocol:

1. Break the outlet cap of the Spin Column. Insert the column into 1.5-ml tube (2-ml tube is even better). Open the top cap of the Spin Column.

2. Centrifuge the spin column at ˜700 xg (˜3000 rpm) for 3 minutes in a tabletop centrifuge. If the eluted storage buffer in the tube touches the outlet-tip of the column, empty the tube and repeat the centrifuge step one more time. The column matrix should be packed down and semi-dry but should not be cracked.

3. Transfer the spin column to a new 1.5-ml tube (or empty the storage buffer completely from the first tube). Apply 20 to 30 μl of protein samples slowly to the center of the packed column matrix, do not allow the sample to run on the side of the column matrix.

4. Centrifuge at 700 xg for 3 minutes. The purified proteins are in the collection tube.

5. OPTION: To collect smaller and smaller proteins in subsequent fractions, repeat the previous 2 steps with applications of 25 μl aliquots of buffer.

6. Transfer column to a new tube, apply 30 μL of 20 mM Tris-HCl, pH 9.0. A total of four fractions of 30 μL were collected for each sample using the column equilibrated buffer.

B. Protein fractionation by Q anion-exchange spin columns:

Combine fractions 1 and 2 of the K30 column. Adjust the volume to 100 μL using 20 mM Tris-HCl, pH 9.0. Mix well and incubate on ice for 5 min.

Apply 100 μL sample to a strong anion-exchange spin column (e.g., “Q” column from Ciphergen Biosystems, Inc.) that was equilibrated in 20 mM Tris-HCl, pH 9.0. The following protocol was used for the strong anion-exchange spin column:

1. Storage Buffer Exchange:

1. Break the outlet cap of the Spin Column. Insert the column into 1.5-ml tube (2-ml tube is even better).

2. Open the top cap of the spin column. Let the storage buffer drain into the tube by gravity. If the storage buffer does not come down easily, tab the column and tube unit on a hard surface several times, or centrifuge at 1000 rpm for ˜20 seconds.

3. Let storage buffer drained out by gravity until no more drops come out. Empty buffer in the tube.

4. Apply ˜0. 5 ml of desired binding buffer to the column and let it flow through column matrix by gravity. Repeat this step two more times so that at least ten column volumes of new buffer passing through the resin.

2. Protein fractionation/Puriflcation Protocol:

a) Protein samples preparation:

1. Protein samples should be in the same buffer condition used to equilibrate the anion-exchanger spin column. 2. If samples contain high salt or extreme buffering pH (different from the binding buffer), they should be first buffer-exchanged on a size-selection Spin Column (K-3 or K-30) equilibrated with the binding buffer.

3. If samples are in buffer condition that is similar to the binding buffer, then the samples can be diluted ten times (10×) with the binding buffer.

b) Protein Fractionation on Q Anion-exchange Spin Column:

1. Break the outlet cap of the Spin Column. Insert the column into 1.5-ml tube (2-ml tube is even better). Open the top cap of the spin column.

2. Centrifuge the Spin Column at 1000 rpm (˜80 xg) for 20 seconds to 1 minute in a tabletop centrifuge. The column matrix should be packed down and semi-dry but should not be cracked.

3. Transfer the spin column to a new 1.5-ml tube (or empty the storage buffer completely from the first tube). Apply 20 to 500 μl of protein samples (adjusted into the binding buffer) to the top center of the packed column matrix, allow the sample to run through the anion-exchanger resin by gravity for a few minutes or until no more drops come out of the column.

4. Centrifuge at 1000 rpm for 1 minute. The proteins collected in this first collection tube (fraction #1) do not bind to the column because they have neutral or positive net charges at this binding buffer condition, or maybe the capacity of the column run out.

5. OPTION: To maximize the capture of proteins onto anion-exchanger resin, the eluent can be reapplied to the column and follow the last 2 steps.

6. Transfer the column to a second tube. Wash the column with 100 μl binding buffer. Centrifuge at 1000 rpm for 1 minute. Save fraction #2.

7. Transfer the column to a third tube. Apply 100-200 μl of the elution buffer A, let wait for ˜1 minute. Centrifuge at 1000 rpm for 1 minute. Save fraction #3.

8. Transfer the column to a fourth tube. Apply 100-200 μl of the elution buffer B, let wait for ˜1 minute. Centrifuge at 1000 rpm for 1 minute. Save fraction #4.

9. Continue this process for the subsequent elution buffers at lower pH (e.g., pH 6, pH 5, pH4, etc.).

10. Proteins in these fractions are then profiled by the SELDI™ PBS reader using the hydrophobic H4 or the Normal phase arrays.

Elution buffers typically will vary according to buffer (e.g., Tris, sodium acetate, sodium phosphate), buffer strength (e.g., 20 mM -50 mM), salt concentration (e.g., 20 mM to 1 M NaCi) and pH (e.g., pH 9 to 3).

C. Proteins on SELDI chips:

Concentration SELDI using Normal Phase Chips

Normal phase chips from Ciphergen Biosystems, Inc. were used for profiling proteins in the fractions generated by spin columns and the unfractionated samples containing bovine serum +/− HRP. A 1 μL aliquot of each fraction or of the unfractionated samples was deposited to a spot on the normal phase chip, sample was let dry at room temperature for about 5 minutes. An additional volume of the same sample can be applied to the same spot and permitted to dry.

0.5 μl of saturated sinapinic acid (SPA) in 50% acetonitrile +0.25% TFA was applied to each spot. Chip was allowed to dry at room temperature for 5 minutes. A second aliquot of 0.5 μl saturated SPA sinapinic acid in 50% acetonitrile +0.25% TFA solution was applied. The samples were analyzed using a Protein Biology System I (PBS I) reader from Ciphergen Biosystems, Inc. as described below.

Concentration SELDI using Reverse Phase H4 chips

Reverse Phase H4 hydrophobic chips (available from Ciphergen Biosystems, Inc.) were especially used for fractions containing high concentration of NaCl. A 1 μL aliquot of each fraction was deposited to a spot on the normal phase chip, sample was let dry at room temperature for about 5 minutes. Additional volume of the same sample can be applied to the same spot and permitted to dry.

0.5 μl of saturated sinapinic acid (SPA) in 50% acetonitrile +0.25% TFA was applied to each spot. Chip was allowed to dry at room temperature for 5 minutes. A second aliquot of 0.5 μl saturated SPA sinapinic acid in 50% acetonitrile +0.25% TFA solution was applied.

If the samples contained high amounts of salt, the reverse phase H4 chip can be washed with 5 μL of water twice before letting it dry.

D. Data Acquisition and Protein profile Analysis:

Each chip was read by the Protein Biology System I (PBS I) reader from Ciphergen Biosystems, Inc.

Auto mode was used for data collection, SELDI quantitation setting. Two set of protein profiles are collected, one at low laser intensity, and one at high laser intensity.

The mass spectra of the unfractionated sample without added HRP (FIG. 2, top panel) and the unfractionated sample with added HRP (FIG. 2, second panel from the top) analyzed using a Normal Phase ProteinChip® show that HRP is not detected in the sample with the added HRP. However, using a Normal Phase ProteinChip®, a peak corresponding to HRP is seen in the mass spectrum of the pH 8 fraction of the Q column for the sample containing HRP, (FIG. 2, fourth panel from the top), whereas a similar peak is not evidenced for HRP in the mass spectrum of the pH 8 fraction of the Q column for the sample that did not contain HRP (FIG. 2, third panel from the top).

### Example 2

### Comparison Of MALDI And Concentration SELDI Analysis Of A Tryptic Digest Of Myoglobin

Picomole quantities of Heat-denatured horse heart myoglobin (Sigma) were digested with less than a microgram of trypsin (Roche Diagnostics; Roche Molecular Biochemicals). The trypsin was inactivated with heat by heating at 90° C. for 10 minutes. The digest was then analyzed using MALDI and concentration SELDI.

For the MALDI analysis, 1 μl of the digest and 1 μl of 20% saturated CHCA in 50% acetonitrile and 0.1% TFA were mixed and spotted on a Gold array, which is a stainless steel array coated with a thin layer of gold. The spotted mixture was dried completely on the spot before mass spectrometry analysis. Mass spectrometric analysis was carried out using the Protein Biology System II (PBS II) reader from Ciphergen Biosystems. Data was collected by automatic mode at fixed laser intensity after the laser intensity and detector gain had been determined for signals to be on-scale (mainly peaks above 500 Da). About one hundred spectra was added to the “average” spectrum at 5 to 10 different locations on each spot.

In the “Concentration” SELDI method, areas where the peptide digests would be spotted were first treated with 50% acetonitrile. The acetonitrile was removed before application of the sample. Then 1 μl of the tryptic myoglobin digest from above was spotted on a reverse phase H4 ProteinChip® array (Ciphergen Biosystems, Fremont, Calif.). The spotted digest was permitted to concentrate to almost dryness. Then 1 μl of 20% saturated CHCA in 50% acetonitrile and 0.1% TFA was applied to the spot. The spot was dried completely before mass spectrometry analysis. Mass spectrometric analysis of the sample was carried out similarly to the MALDI method described previously. Data was collected by automatic mode at fixed laser intensity after the laser intensity and detector gain had been determined for signals to be on-scale (mainly peaks above 500 Da). About one hundred spectra was added to the “average” spectrum at 5 to 10 different locations on each spot. RESULTS

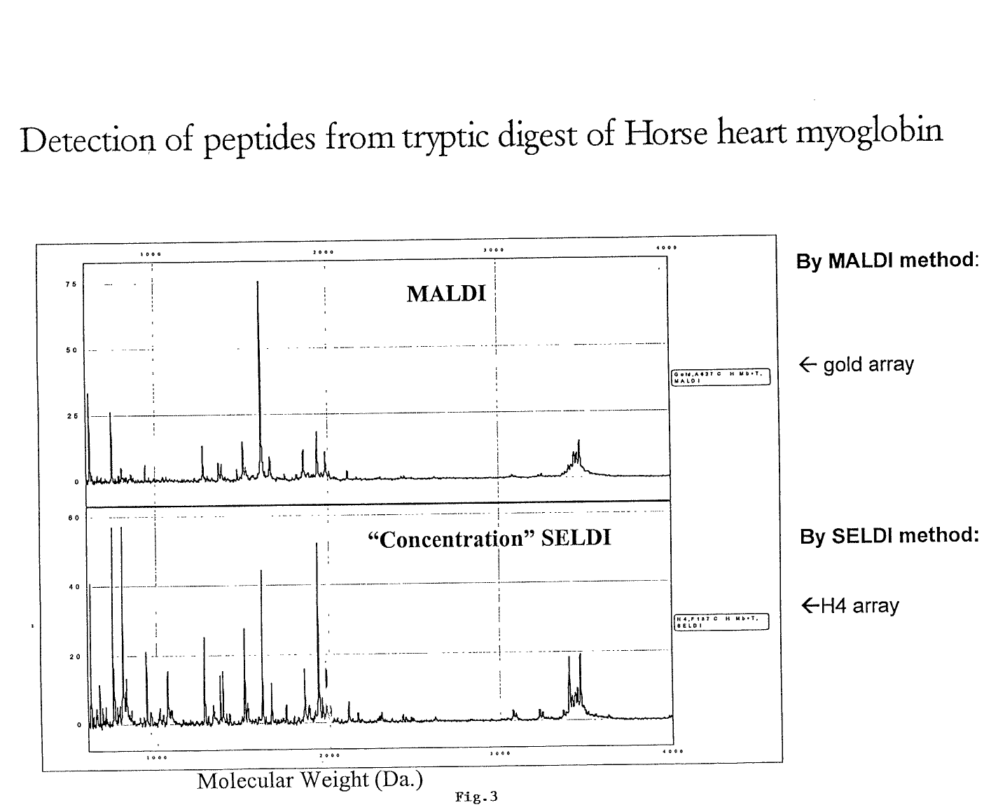

Inspection of the mass spectrum from the MALDI method (see FIG. 3, upper panel) and the mass spectrum of the Concentration SELDI (see FIG. 3, lower panel) reveals that there are several peaks that are visible in the Concentration SELDI spectrum that are not visible at the same mass in the MALDI spectrum. This indicates that the Concentration SELDI method is more sensitive that the MALDI method carried out in this example. In addition there are several peaks in the Concentration SELDI spectrum that have a greater amplitude than peaks with the same mass are visible in the MALDI spectrum.

The present invention provides novel materials and methods for analyzing biomolecular analytes in a sample. While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined not with reference to the above description, but instead should be determined with reference to the appended claims along with their full scope of equivalents.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

What is claimed is:

1. A method for detecting bioorganic molecules in a sample comprising:
(a) contacting a sample comprising bioorganic molecules with an adsorbent surface of a probe;
(b) concentrating the bioorganic molecules in the sample on the adsorbent surface; and
(c) detecting the bioorganic molecule(s) on the adsorbent surface of the probe by gas phase ion spectrometry.

2. The method of claim 1, wherein the gas phase ion spectrometry comprises laser desorption/ionization mass spectrometry.

3. The method of claim 2, wherein the sample comprises a biological fluid selected from saliva, blood, urine, lymphatic fluid, prostatic or seminal fluid, milk, a cell extract and cell culture medium.

4. The method of claim 2, wherein the adsorbent is selected from a hydrophilic adsorbent and a hydrophobic adsorbent.

5. The method of claim 2, wherein the adsorbent comprises silicon oxide.

6. The method of claim 2, wherein concentrating comprises concentrating the sample to dryness.

7. The method of claim 6, further comprising applying an energy absorbing material to the probe after concentrating.

8. The method of claim 7, wherein the energy absorbing molecule is a member selected from the group consisting of: a cinnamic acid derivative, sinapinic acid and dihydroxybenzoic acid.

9. The method of claim 2, wherein the sample is pre-fractionated by size exclusion chromatography and/or ion exchange chromatography before contact with the adsorbent surface.

10. A method for detecting bioorganic molecules in a sample comprising:
(a) contacting a sample comprising bioorganic molecules with an adsorbent surface of a probe;
(b) allowing the sample to reach binding equilibrium with the adsorbent;
(c) removing sample liquid from the adsorbent surface without washing the adsorbent surface; and
(d) detecting the bioorganic molecules on the adsorbent surface of the probe by gas phase ion spectrometry.

11. The method of claim 10, wherein gas phase ion spectrometry comprises laser desorption/ionization mass spectrometry.

12. The method of claim 11, wherein the sample comprises a biological fluid selected from saliva, blood, urine, lymphatic fluid, prostatic or seminal fluid, milk, a cell extract and cell culture medium.

13. The method of claim 11, wherein the adsorbent is selected from a hydrophilic adsorbent and a hydrophobic adsorbent.

14. The method of claim 11, wherein the adsorbent comprises silicon oxide.

15. The method of claim 6, further comprising applying an energy absorbing material to the probe after removing liquid sample.

16. The method of claim 7, wherein the energy absorbing molecule is a member selected from the group consisting of: a cinnamic acid derivative, sinapinic acid and dihydroxybenzoic acid.

17. The method of claim 17, wherein the sample is pre-fractionated by size exclusion chromatography and/or ion exchange chromatography before contact with the adsorbent surface.
